(19) United States
(12) Patent Application Publication
(10) Pub. No.: US 2025/0098790 A1
(43) Pub. Date: Mar. 27, 2025

(54) AN AEROSOL-GENERATING DEVICE AND A METHOD OF CONTROLLING AEROSOL-PRODUCTION THEREOF

(71) Applicant: Philip Morris Products S.A., Neuchatel (CH)

(72) Inventors: Maxime Clément Charles CHATEAU, Montlebon (FR); Farhang MOHSENI, Neuchatel (CH)

(73) Assignee: Philip Morris Products S.A., Neuchatel (CH)

(21) Appl. No.: 18/852,778

(22) PCT Filed: Mar. 31, 2023
(86) PCT No.: PCT/EP2023/058486

§ 371 Date: Sep. 30, 2024

(30) Foreign Application Priority Data
Apr. 6, 2022 (EP) 22166996.3

(51) Int. Cl. A24F 40/57; A24D 1/20; A24F 40/20; A24F 40/46; G05D 23/24

(52) U.S. Cl. CPC A24F 40/57; A24D 1/20; A24F 40/20; A24F 40/46; G05D 23/24

(57) ABSTRACT

A method of controlling aerosol production in an aerosol-generating device is provided, the device including a heating chamber to receive an aerosol-generating article including an aerosol-forming substrate; a heating system including a heating element to externally heat the substrate; and a power source to provide power to the heating system, the method including: controlling the power during heating of the substrate to form an aerosol for inhalation by a user to: increase a temperature of the heating element from an initial temperature to a first temperature, maintain the first temperature constant for a first time period, and adjust the temperature of the heating element to a second temperature for a second time period, the second time period being directly subsequent to the first time period, and the second time period being longer than the first time period.

The present disclosure relates to a method of controlling aerosol production in an aerosol-generating device that is configured to heat an aerosol-generating article comprising a solid or a gel aerosol-forming substrate. The present disclosure also relates to the aerosol-generating device and a system comprising the aerosol-generating device and the aerosol-generating article.

Aerosol-generating devices may comprise an electrically operated heat source that is configured to heat an aerosol-generating article comprising an aerosol-forming substrate to generate an aerosol. Typically, in heated aerosol-generating articles, an aerosol is generated by the transfer of heat from the heat source to a physically separate aerosol-forming substrate. In use, volatile compounds are released from the aerosol-forming substrate by heat transfer to the aerosol-forming substrate from the heat source and entrained in air drawn through the aerosol-generating article. As the released compounds cool, they condense to form an aerosol that is inhaled by the user.

A number of handheld aerosol-generating devices configured to heat aerosol-forming substrates of heated aerosol-generating articles are known in the art. These include electrically-operated aerosol-generating devices in which an aerosol is generated by the transfer of heat from one or more electrical heating elements of the aerosol-generating device to the aerosol-forming substrate of the heated aerosol-generating article. Known handheld electrically operated aerosol-generating devices typically comprise a battery, control electronics and one or more electrical heating elements for heating the aerosol-forming substrate of a heated aerosol-generating article.

It would be desirable to provide an aerosol-generating device and method of controlling aerosol-production in the aerosol-generating device in which a large amount of volatile compounds are delivered to the user from the first puff and that good deliveries of the volatile compounds are maintained throughout the user experience.

According to an embodiment, there is provided a method of controlling aerosol production in an aerosol-generating device. The device comprises: a heating chamber configured to at least partially receive an aerosol-generating article comprising an aerosol-forming substrate; a heating system comprising a heating element that is configured to externally heat the aerosol-forming substrate; and a power source for providing power to the heating system. The method comprises controlling the power during heating of the aerosol-forming substrate to form an aerosol for inhalation by a user to: increase a temperature of the heating element from an initial temperature to a first temperature, wherein said first temperature is maintained constant for a first predetermined time period, and wherein said first temperature is between 180 and 230 degrees Celsius; and adjust the temperature of the heating element to a second temperature for a second predetermined time period, wherein the second predetermined time period is directly subsequent to the first predetermined time period, and wherein the second predetermined time period is longer than the first predetermined time period.

By heating the heating element to within this range of temperatures for the first predetermined period of time, the thermal inertia of the aerosol-forming substrate is overcome and the amount of vaporized desired volatile compounds in the aerosol inhaled by the user is improved from the first puff.

As used herein with reference to the invention, the term “aerosol-generating device” is used to describe a device that interacts with the aerosol forming substrate of an aerosol generating article to generate an aerosol. The aerosol-generating device may be a handheld electrically-operated device.

As used herein with reference to the invention, the term “aerosol-generating article” is used to describe an article comprising an aerosol-forming substrate that is heated to generate an inhalable aerosol for delivery to a user. An aerosol-generating article may be disposable.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapors of substances that are ordinarily liquid or solid at room temperature as well as solid particles, or liquid droplets, or a combination of solid particles and liquid droplets.

As used herein with reference to the invention, the term “aerosol-forming substrate” is used to describe a substrate comprising aerosol-generating material that is capable of releasing upon heating volatile compounds that can generate an aerosol.

Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heating system.

The heating element may be a resistive heater.

The heating element may be a tubular heating element that is configured to surround the aerosol-forming substrate when in use.

The first predetermined time period may have a duration of between 40 seconds and 150 seconds.

A time period for increasing the temperature of the heating element from the initial temperature to the first temperature may have a duration of 3 to 5 seconds.

The second temperature may be different to the first temperature.

Adjusting the temperature of the heating element to the second temperature during the second predetermined time period may comprise lowering the temperature of the heating element from the first temperature.

Lowering the temperature of the heating element during the second predetermined time period enables the amount of vaporized desired volatile compounds in the aerosol inhaled by the user to remain consistent with the amount vaporized during the first predetermined time, thereby providing the same sensorial experience for the user.

Adjusting the temperature of the heating element to the second temperature during the second predetermined time period may comprise lowering the temperature of the heating element from the first temperature to the second temperature and subsequently increasing the temperature of the heating element in a step-wise manner.

Lowering the heater temperature from the first temperature may comprise two consecutive temperature steps.

A temperature of a first temperature step may be lower than a temperature of a second temperature step.

Having two temperature steps in the second predetermined time period allows for improved control of the amount of vaporized desired volatile compounds in the aerosol inhaled by the user, thereby providing the same sensorial experience for the user. Further, if the temperature of the second heating step is higher than the temperature of the first heating step, the amount of desired vaporized volatile compounds remains consistent even though the amount of desired volatile compounds depletes over time with heating.

The second temperature may be between 145 and 185 degrees Celsius.

Adjusting the heater temperature to the second temperature during the second predetermined time period may comprise increasing the heater temperature from the first temperature.

The temperature of the heating element during the second predetermined time period may be between 200 and 240 degrees Celsius.

A duration of the second predetermined time period may be between 100 and 280 seconds.

Controlling the power during heating of the aerosol-forming substrate to form an aerosol for inhalation by a user may further comprise adjusting the temperature of the heating element to be constant and equal to a third temperature during a third predetermined time period, wherein the third temperature approximately corresponds to the first temperature and the third predetermined time period is subsequent to the second predetermined time period. The third predetermined time period may be directly subsequent to the second predetermined time period.

A duration of the third predetermined time period may be between 30 seconds and 120 seconds.

Performing the heating of the aerosol-forming substrate to form an aerosol for inhalation by a user into three predetermined time periods in which the temperature of the heating element is adjusted to a respective temperature, enables improved control of aerosol delivery. In particular, towards the end of a user session in the third predetermined time period, the amount of desired volatile compounds to be vaporized for inhalation by the user will be depleted. Increasing the temperature of the heating element to approximately the first temperature enables the amount of vaporized desired volatile compounds in the aerosol inhaled by the user to remain consistent with the amount in the first and second predetermined time periods.

The power may be controlled during heating of the aerosol-forming substrate to form an aerosol for inhalation by a user based on a heating profile of a plurality of heating profiles, wherein each heating profile defines how to adjust the temperature of the heating element during each of the predetermined time periods.

The method may further comprise selecting the heating profile based on identifying the aerosol-generating article.

The power may be controlled during heating of the aerosol-forming substrate to form an aerosol for inhalation by a user based on a heating profile of a plurality of heating profiles, wherein each heating profile defines how to adjust the temperature of the heating element during the second predetermined time period.

The method may further comprise selecting the heating profile based on identifying the aerosol-generating article.

Controlling the power may further comprise: in a pre-heating mode, increasing the temperature of the heating element from an ambient temperature to the initial temperature.

The pre-heating mode ensures that, whatever the physical condition of the aerosol-forming substrate (dry or humid, for example), the time duration of the pre-heating mode is sufficient for the aerosol-forming substrate to reach a minimum operating temperature, in order to be ready to feed continuous power and reach the first operating temperature as quickly as possible for generating sufficient aerosol to be inhaled by the user. This is particularly advantageous for aerosol-forming substrates having a high aerosol former content (greater than 30 percent by weight) because such substrates typically have a higher moisture content after thermal equilibrium has been reached.

The initial temperature may be between 140 and 170 degrees Celsius.

According to a further embodiment, there is provided an aerosol-generating device comprising: a heating chamber configured to at least partially receive an aerosol-generating article comprising an aerosol-forming substrate; a heating system comprising a heating element that is configured to externally heat the aerosol-forming substrate; a power source for providing power to the heating system; and a controller configured to control the power during heating of the aerosol-forming substrate to form an aerosol for inhalation by a user to: increase a temperature of the heating element from an initial temperature to a first temperature, wherein said first temperature is maintained constant for a first predetermined time period, and wherein said first temperature is between 180 and 230 degrees Celsius; and adjust the temperature of the heating element to a second temperature for a second predetermined time period, wherein the second predetermined time period is directly subsequent to the first predetermined time period, and wherein the second predetermined time period is longer than the first predetermined time period.

The heating element may be a resistive heater.

The heating element may be a tubular heating element that is configured to surround the aerosol-forming substrate when in use.

The first predetermined time period may have a duration of between 40 seconds and 150 seconds.

A time period for increasing the temperature of the heating element from the initial temperature to the first temperature may be between 3 and 5 seconds.

The second temperature may be different to the first temperature.

Adjusting the temperature of the heating element to the second temperature during the second predetermined time period may comprise lowering the temperature of the heating element from the first temperature.

Adjusting the temperature of the heating element to the second temperature during the second predetermined time period may comprise lowering the temperature of the heating element from the first temperature to the second temperature and subsequently increasing the temperature of the heating element in a step-wise manner.

Lowering the heater temperature from the first temperature may comprise two consecutive temperature steps.

A temperature of a first temperature step may be lower than a temperature of a second temperature step.

The second temperature may be between 145 and 185 degrees Celsius.

Adjusting the heater temperature to the second temperature during the second predetermined time period may comprise increasing the heater temperature from the first temperature.

The temperature of the heating element during the second predetermined time period may be between 200 and 240 degrees Celsius.

A duration of the second predetermined time period may between 100 and 280 seconds.

The controller may be further configured to control the power during heating of the aerosol-forming substrate to form an aerosol for inhalation by a user to adjust the temperature of the heating element to be constant and equal to a third temperature during a third predetermined time period, wherein the third temperature approximately corresponds to the first temperature and the third predetermined time period is subsequent to the second predetermined time period. The third predetermined time period may be directly subsequent to the first predetermined time period.

A duration of the third predetermined time period may be between 30 seconds and 120 seconds.

The aerosol-generating device may further comprise a memory configured to store a plurality of heating profiles, wherein each heating profile defines how to adjust the temperature of the heating element during each of the time periods, and wherein the controller is further configured to control the power during heating of the aerosol-forming substrate to form an aerosol for inhalation by a user based on a heating profile of the plurality of heating profiles.

The controller may be further configured to select the heating profile based on identifying the aerosol-generating article.

The aerosol-generating device may further comprise a memory configured to store a plurality of heating profiles, wherein each heating profile defines how to adjust the temperature of the heating element during the second predetermined time period, and wherein the controller is further configured to control the power during heating of the aerosol-forming substrate to form an aerosol for inhalation by a user based on a heating profile of the plurality of heating profiles.

The controller may be further configured to select the heating profile based on identifying the aerosol-generating article.

The controller may be further configured to control the power to: in a pre-heating mode, increase the temperature of the heating element from an ambient temperature to the initial temperature.

The initial temperature may be between 140 and 170 degrees Celsius.

According to a further embodiment, there is provided a system comprising: the aerosol-generating device described above; and an aerosol-generating article comprising the aerosol-forming substrate.

The aerosol-forming substrate may comprise one or more aerosol formers, and wherein the aerosol-forming substrate comprises a total aerosol former content greater than or equal to 30 percent by weight.

As used herein with reference to the invention, the term “aerosol former” is used to describe a compound that, in use, facilitates formation of the aerosol, and that preferably is substantially resistant to thermal degradation at the operating temperature of an aerosol-generating article or aerosol-generating system comprising the aerosol-forming substrate.

As used herein with reference to the invention, the term “total aerosol former content” is used to describe the combined content of all aerosol formers in the aerosol-forming substrate.

Unless stated otherwise, percentages by weight of components of the aerosol-forming substrate recited herein are based on the dry weight of the aerosol-forming substrate.

The one or more aerosol formers may comprise at least one of 1,3-butanediol, glycerin, 1,3-propanediol, propylene glycol, triethylene glycol, glycerol monoacetate, glycerol diacetate, glycerol triacetate, dimethyl dodecanedioate and dimethyl tetradecanedioate.

The aerosol-forming substrate may be a non-tobacco substrate.

The aerosol-forming substrate may be a solid or a gel.

As used herein with reference to the invention, the term “solid” is used to describe an aerosol-forming substrate that has a stable size and shape and does not flow at 23° C.

As used herein with reference to the invention, the term “gel” is used to describe an aerosol-forming substrate that comprises two or more components, one of which is a liquid. A gel is mostly liquid by weight. A gel is a substantially dilute cross-linked system, which exhibits no flow when in the steady state, although the liquid phase may still diffuse through the system.

The aerosol-forming substrate may further comprise nicotine.

As used herein with reference to the invention, the term “nicotine” is used to describe nicotine, a nicotine base or a nicotine salt. In embodiments in which the aerosol-forming substrate comprises a nicotine base or a nicotine salt, the amounts of nicotine recited herein are the amount of free base nicotine or amount of protonated nicotine, respectively.

The aerosol-forming substrate may comprise natural nicotine, or synthetic nicotine, or a combination of natural nicotine and synthetic nicotine.

The aerosol-forming substrate may further comprise one or more cellulose based agents and one or more carboxylic acids selected from fumaric acid, maleic acid and malic acid.

The aerosol-forming substrate may have a total cellulose based agent content of at least 35 percent by weight and a total carboxylic acid content of at least 0.5 percent by weight.

The aerosol-forming substrate may comprise water.

The aerosol-forming substrate may have a water content of between 5 percent by weight and 35 percent by weight.

The aerosol-forming substrate may be a solid film.

As used herein with reference to the invention, the term “film” is used to describe a solid aerosol-forming substrate having a thickness that is substantially less than the width or length thereof.

As used herein with reference to the invention, the term “thickness” is used to describe the minimum dimension between opposite, substantially parallel surfaces of a solid aerosol-generating film.

As used herein, the terms “puff” and “inhalation” are used interchangeably and are intended to mean the action of a user drawing an aerosol into their body through their mouth or nose. Inhalation includes the situation where an aerosol is drawn into the user's lungs, and also the situation where an aerosol is only drawn into the user's mouth or nasal cavity before being expelled from the user's body.

As used herein, a “usage session” refers to a period of use of the device beginning with activation of the device by the user. The usage session may comprise a pre-heating phase in which the aerosol-generating device is configured to supply power to the heating system to heat the aerosol-forming substrate to generate aerosol. The usage session may comprise a calibration phase to calibrate the heating system in order to more accurately control the temperature of the heating element. The usage session may comprise a main phase during which the user may inhale the generated aerosol. The main phase may be 30 long enough for a plurality of puffs. The main phase may be long enough for three, four, five or six puffs. The main phase may be long enough for more than six puffs. At the end of the usage phase, the aerosol-generating device may be configured to stop supplying power to the heating system. The aerosol-forming substrate may be removed from the aerosol-generating device at the end of the usage session. The aerosol-forming substrate may be replaced in a later usage session. The duration of the usage session, between a usage session start and a usage session end may be at least one, two, three, four, five or six minutes. Preferably, the usage session may have a duration of about four and a half minutes.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

As used herein, “aerosol-cooling element” refers to a component of an aerosol-generating article located downstream of the aerosol-forming substrate such that, in use, an aerosol formed by volatile compounds released from the aerosol-forming substrate passes through and is cooled by the aerosol cooling element before being inhaled by a user. An aerosol cooling element has a large surface area, but causes a low pressure drop. Filters and other mouthpieces that produce a high pressure drop, for example filters formed from bundles of fibers, are not considered to be aerosol-cooling elements. Chambers and cavities within an aerosol-generating article are not considered to be aerosol cooling elements.

As used herein, the term “mouthpiece” refers to a portion of an aerosol-generating article, an aerosol-generating device or an aerosol-generating system that is placed into a user's mouth in order to directly inhale an aerosol.

As used herein with reference to the invention, the term “mode” refers to a mode of operation that the controller is programmed to perform. For example, in a pre-heating mode, the controller is configured to perform a pre-programmed pre-heating process. In a heating mode, the controller is configured to perform a heating process. The term “phase” may be used herein interchangeably with the term “mode”. The controller may be a microcontroller. The controller may comprise a microprocessor, such as a programmable microprocessor. The controller may comprise a non-volatile memory. The aerosol-generating device may comprise an interface configured to allow for the transfer of data to and from the controller from external devices. The interface may allow for the uploading of software to the controller to run on the programmable microprocessor. The interface may be a wired interface, such as a micro USB port, or may be a wireless interface.

The invention is defined in the claims. However, below there is provided a non-exhaustive list of non-limiting examples. Any one or more of the features of these examples may be combined with any one or more features of another example, embodiment, or aspect described herein.

### Example Ex1

A method of controlling aerosol production in an aerosol-generating device, the device comprising: a heating chamber configured to at least partially receive an aerosol-generating article comprising an aerosol-forming substrate; a heating system comprising a heating element that is configured to externally heat the aerosol-forming substrate; and a power source for providing power to the heating system, the method comprising controlling the power during heating of the aerosol-forming substrate to form an aerosol for inhalation by a user to: increase a temperature of the heating element from an initial temperature to a first temperature, wherein said first temperature is maintained constant for a first predetermined time period, and wherein said first temperature is between 180 and 230 degrees Celsius; and adjust the temperature of the heating element to a second temperature for a second predetermined time period, wherein the second predetermined time period is directly subsequent to the first predetermined time period, and wherein the second predetermined time period is longer than the first predetermined time period.

### Example Ex2

The method according to example Ex1, wherein the heating element is a resistive heater.

### Example Ex3

The method according to example Ex1 or Ex2, wherein the heating element is a tubular heating element that is configured to surround the aerosol-forming substrate when in use.

### Example Ex4

The method according to one of the preceding examples, wherein the first predetermined time period has a duration of between 40 seconds and 150 seconds.

### Example Ex5

The method according to one of the preceding examples, wherein a time period for increasing the temperature of the heating element from the initial temperature to the first temperature has a duration of 3 to 5 seconds.

### Example Ex6

The method according to one of the preceding examples, wherein the second temperature is different to the first temperature.

### Example Ex7

The method according to one of the preceding examples, wherein adjusting the temperature of the heating element to the second temperature during the second predetermined time period comprises lowering the temperature of the heating element from the first temperature.

### Example Ex8

The method according to one of the preceding examples, wherein adjusting the temperature of the heating element to the second temperature during the second predetermined time period comprises lowering the temperature of the heating element from the first temperature to the second temperature and subsequently increasing the temperature of the heating element in a step-wise manner.

### Example Ex9

The method according to example Ex7 or Ex8, wherein lowering the heater temperature from the first temperature comprises two consecutive temperature steps.

### Example Ex10

The method according to example Ex9, wherein a temperature of a first temperature step is lower than a temperature of a second temperature step.

### Example Ex11

The method according to one of the preceding examples, wherein the second temperature is between 145 and 185 degrees Celsius.

### Example Ex12

The method according to one of examples Ex1 to Ex6, wherein adjusting the heater temperature to the second temperature during the second predetermined time period comprises increasing the heater temperature from the first temperature.

### Example Ex13

The method according to example Ex12, wherein the temperature of the heating element during the second predetermined time period is between 200 and 240 degrees Celsius.

### Example Ex14

The method according to one of the preceding examples, wherein a duration of the second predetermined time period is between 100 and 280 seconds.

### Example Ex15

The method according to the preceding examples, wherein controlling the power during heating of the aerosol-forming substrate to form an aerosol for inhalation by a user further comprises adjusting the temperature of the heating element to be constant and equal to a third temperature during a third predetermined time period, wherein the third temperature approximately corresponds to the first temperature and the third predetermined time period is subsequent to the second predetermined time period.

### Example Ex16

The method according to example Ex15, wherein a duration of the third predetermined time period is between 30 seconds and 120 seconds.

### Example Ex17

The method according to one of the preceding examples, wherein the power is controlled during heating of the aerosol-forming substrate to form an aerosol for inhalation by a user based on a heating profile of a plurality of heating profiles, wherein each heating profile defines how to adjust the temperature of the heating element during each of the predetermined time periods.

### Example Ex18

The method according to example Ex17, further comprising selecting the heating profile based on identifying the aerosol-generating article.

### Example Ex19

The method according to one of examples Ex1 to Ex16, wherein the power is controlled during heating of the aerosol-forming substrate to form an aerosol for inhalation by a user based on a heating profile of a plurality of heating profiles, wherein each heating profile defines how to adjust the temperature of the heating element during the second predetermined time period.

### Example Ex20

The method according to example Ex19, further comprising selecting the heating profile based on identifying the aerosol-generating article.

### Example Ex21

The method according to one of the preceding examples, wherein controlling the power further comprises: in a pre-heating mode, increasing the temperature of the heating element from an ambient temperature to the initial temperature.

### Example Ex22

The method according to example Ex21, wherein the initial temperature is between 140 and 170 degrees Celsius.

### Example Ex23

An aerosol-generating device, comprising: a heating chamber configured to at least partially receive an aerosol-generating article comprising an aerosol-forming substrate; a heating system comprising a heating element that is configured to externally heat the aerosol-forming substrate; a power source for providing power to the heating system; and a controller configured to control the power during heating of the aerosol-forming substrate to form an aerosol for inhalation by a user to: increase a temperature of the heating element from an initial temperature to a first temperature, wherein said first temperature is maintained constant for a first predetermined time period, and wherein said first temperature is between 180 and 230 degrees Celsius; and adjust the temperature of the heating element to a second temperature for a second predetermined time period, wherein the second predetermined time period is directly subsequent to the first predetermined time period, and wherein the second predetermined time period is longer than the first predetermined time period.

### Example Ex24

The aerosol-generating device according to example Ex23, wherein the heating element is a resistive heater.

### Example Ex25

The aerosol-generating device according to example Ex23 or Ex24, wherein the heating element is a tubular heating element that is configured to surround the aerosol-forming substrate when in use.

### Example Ex26

The aerosol-generating device according to one of examples Ex23 to Ex25, wherein the first predetermined time period has a duration of between 40 seconds and 150 seconds.

### Example Ex27

The aerosol-generating device according to one of examples Ex23 to Ex26, wherein a time period for increasing the temperature of the heating element from the initial temperature to the first temperature is 3 to 5 seconds.

### Example Ex28

The aerosol-generating device according to one of examples Ex23 to Ex27, wherein the second temperature is different to the first temperature.

### Example Ex29

The aerosol-generating device according to one of examples Ex23 to Ex28 wherein adjusting the temperature of the heating element to the second temperature during the second predetermined time period comprises lowering the temperature of the heating element from the first temperature.

### Example Ex30

The aerosol-generating device according to one of examples Ex23 to Ex29, wherein adjusting the temperature of the heating element to the second temperature during the second predetermined time period comprises lowering the temperature of the heating element from the first temperature to the second temperature and subsequently increasing the temperature of the heating element in a step-wise manner.

### Example Ex31

The aerosol-generating device according to example Ex29 or Ex30, wherein lowering the heater temperature from the first temperature comprises two consecutive temperature steps.

### Example Ex32

The aerosol-generating device according to example Ex31, wherein a temperature of a first temperature step is lower than a temperature of a second temperature step.

### Example Ex33

The aerosol-generating device according to one of examples Ex23 to Ex32, wherein the second temperature is between 145 and 185 degrees Celsius.

### Example Ex34

The aerosol-generating device according to one of examples Ex23 to Ex28, wherein adjusting the heater temperature to the second temperature during the second predetermined time period comprises increasing the heater temperature from the first temperature.

### Example Ex35

The aerosol-generating device according to example Ex34, wherein the temperature of the heating element during the second predetermined time period is between 200 and 240 degrees Celsius.

### Example Ex36

The aerosol-generating device according to one of examples Ex23 to Ex35, wherein a duration of the second predetermined time period is between 100 and 280 seconds.

### Example Ex37

The aerosol-generating device according to one of examples Ex23 to Ex36, wherein the controller is further configured to control the power during heating of the aerosol-forming substrate to form an aerosol for inhalation by a user to adjust the temperature of the heating element to be constant and equal to a third temperature during a third predetermined time period, wherein the third temperature approximately corresponds to the first temperature and the third predetermined time period is subsequent to the second predetermined time period.

### Example Ex38

The aerosol-generating device according to example Ex37, wherein a duration of the third predetermined time period is between 30 seconds and 120 seconds.

### Example Ex39

The aerosol-generating device according to one of examples Ex23 to Ex38, wherein the aerosol-generating device further comprises a memory configured to store a plurality of heating profiles, wherein each heating profile defines how to adjust the temperature of the heating element during each of the time periods, and wherein the controller is further configured to control the power during heating of the aerosol-forming substrate to form an aerosol for inhalation by a user based on a heating profile of the plurality of heating profiles.

### Example Ex40

The aerosol-generating device according to example Ex39, wherein the controller is further configured to select the heating profile based on identifying the aerosol-generating article.

### Example Ex41

The aerosol-generating device according to one of examples Ex23 to Ex38, wherein the aerosol-generating device further comprises a memory configured to store a plurality of heating profiles, wherein each heating profile defines how to adjust the temperature of the heating element during the second predetermined time period, and wherein the controller is further configured to control the power during heating of the aerosol-forming substrate to form an aerosol for inhalation by a user based on a heating profile of the plurality of heating profiles.

### Example Ex42

The aerosol-generating device according to example Ex41, wherein the controller is further configured to select the heating profile based on identifying the aerosol-generating article.

### Example Ex43

The aerosol-generating device according to one of examples Ex23 to Ex42, wherein the controller is further configured to control the power to: in a pre-heating mode, increase the temperature of the heating element from an ambient temperature to the initial temperature.

### Example Ex44

The aerosol-generating device according to example Ex43, wherein the initial temperature is between 140 and 170 degrees Celsius.

### Example Ex45

A system comprising: the aerosol-generating device according to one of examples 23 to 44; and an aerosol-generating article comprising the aerosol-forming substrate.

### Example Ex46

The system according to example Ex45, wherein the aerosol-forming substrate comprises one or more aerosol formers, and wherein the aerosol-forming substrate comprises a total aerosol former content greater than or equal to 30 percent by weight.

### Example Ex47

The system according to example Ex46, wherein the one or more aerosol formers comprise at least one of 1,3-butanediol, glycerin, 1,3-propanediol, propylene glycol, triethylene glycol, glycerol monoacetate, glycerol diacetate, glycerol triacetate, dimethyl dodecanedioate and dimethyl tetradecanedioate.

### Example Ex48

The system according to one of examples Ex45 to Ex47, wherein the aerosol-forming substrate is a non-tobacco substrate.

### Example Ex49

The system according to one of examples Ex45 to Ex48, wherein the aerosol-forming substrate is a solid or a gel.

### Example Ex50

The system according to one of examples Ex45 to Ex49, wherein the aerosol-forming substrate further comprises nicotine.

### Example Ex51

The system according to one of examples Ex45 to Ex50, wherein the aerosol-forming substrate further comprises one or more cellulose based agents and one or more carboxylic acids selected from fumaric acid, maleic acid and malic acid.

### Example Ex52

The system according to example Ex51, wherein the aerosol-forming substrate has a total cellulose based agent content of at least 35 percent by weight and a total carboxylic acid content of at least 0.5 percent by weight.

### Example Ex53

The system according to one of examples Ex55 to Ex62, wherein the aerosol-forming substrate comprises water.

### Example Ex54

The system according to example Ex53, wherein the aerosol-forming substrate has a water content of between 5 percent by weight and 35 percent by weight.

Examples will now be further described with reference to the figures in which:

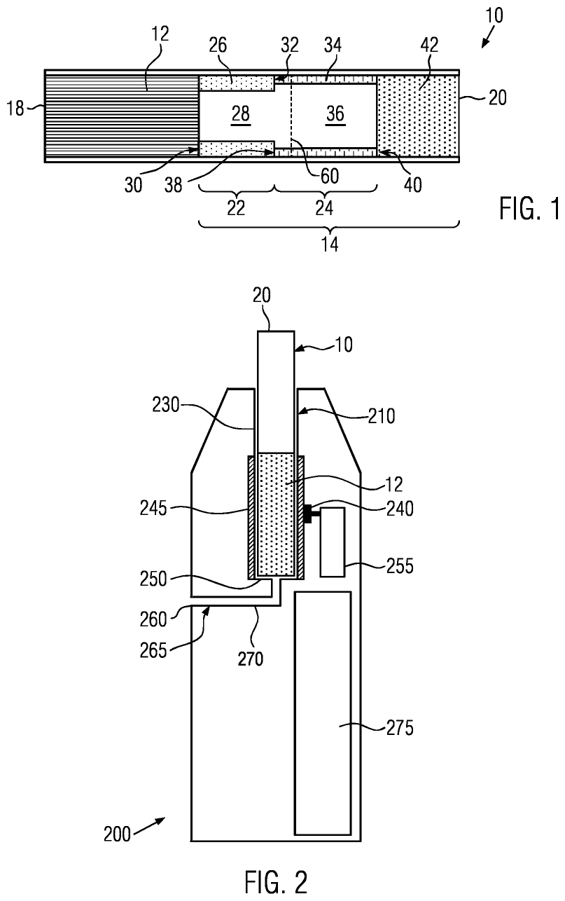

FIG. 1 shows a schematic cross-sectional view of an aerosol-generating article comprising an aerosol-forming substrate;

FIG. 2 shows a schematic cross-sectional view of an aerosol-generating system comprising the aerosol-generating article shown in FIG. 1 and an electrically-operated aerosol-generating device comprising a resistive heater for externally heating the aerosol-forming substrate;

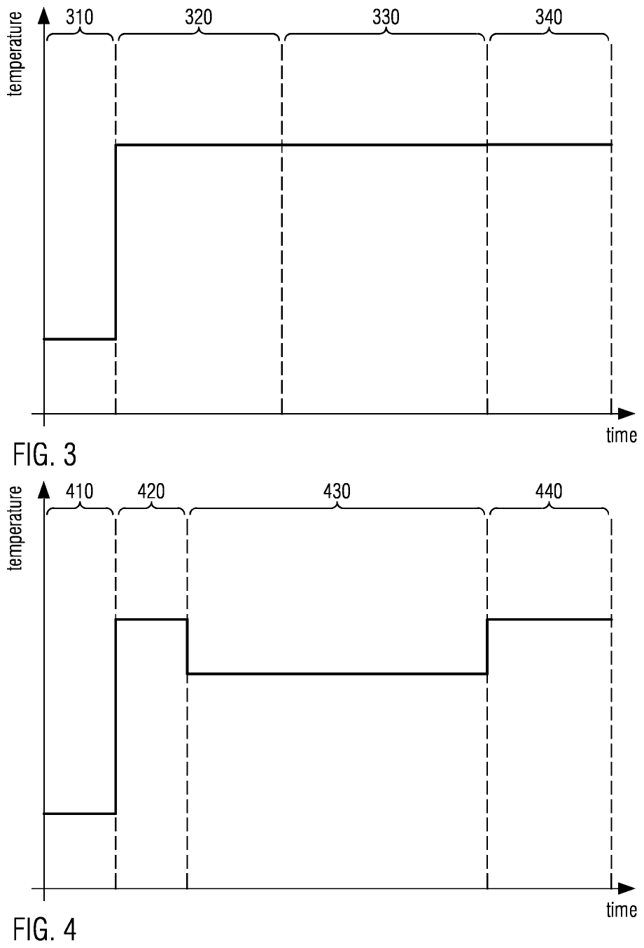

FIG. 3 is a graph of temperature vs. time illustrating part of a heating profile during user operation of the aerosol-generating device;

FIG. 4 is a graph of temperature vs. time illustrating part of a heating profile during user operation of the aerosol-generating device;

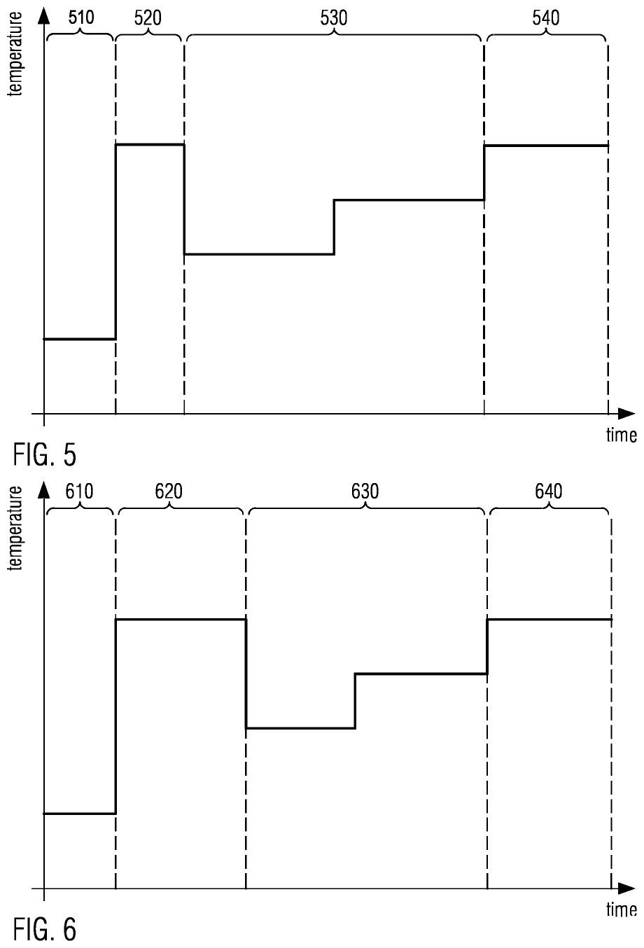

FIG. 5 is a graph of temperature vs. time illustrating part of a heating profile during user operation of the aerosol-generating device;

FIG. 6 is a graph of temperature vs. time illustrating part of a heating profile during user operation of the aerosol-generating device;

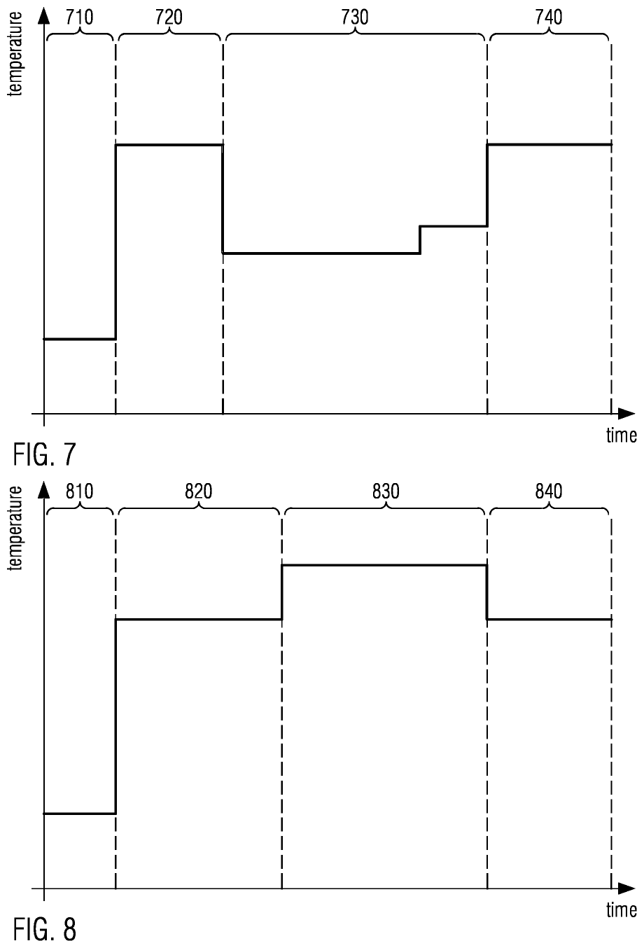

FIG. 7 is a graph of temperature vs. time illustrating part of a heating profile during user operation of the aerosol-generating device;

FIG. 8 is a graph of temperature vs. time illustrating part of a heating profile during user operation of the aerosol-generating device; and

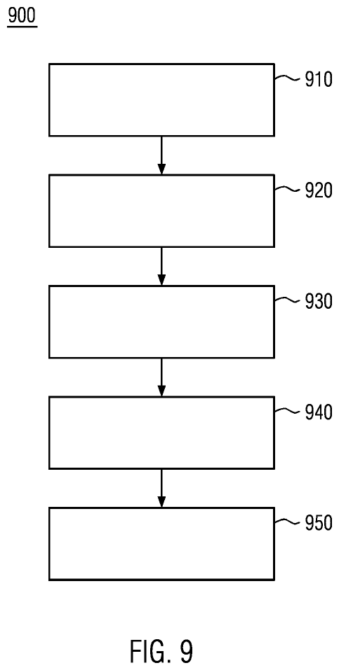

FIG. 9 is a flow diagram of a method of controlling aerosol production in an aerosol-generating device.

FIG. 1 is a schematic cross-sectional view of an aerosol-generating article 10 comprising an aerosol-forming substrate.

The aerosol-generating article 10 shown in FIG. 1 comprises an aerosol-generating rod 12 and a proximal section 14 located downstream of the aerosol-generating rod 12. As shown in FIG. 1, the aerosol-generating article 10 has an upstream or distal end 18 and a downstream or proximal end 20.

The proximal section 14 of the aerosol-generating article 10 comprises a support element 22 located immediately downstream of the aerosol-generating rod 12, an aerosol-cooling element 24 located immediately downstream of the support element 22, and a mouthpiece element 42 located immediately downstream of the aerosol-cooling element 24.

The support element 22 comprises a first hollow tubular segment 26. The first hollow tubular segment 26 is in the form of a hollow cylindrical tube made of cellulose acetate. The first hollow tubular segment 26 defines an internal cavity 28 that extends from an upstream end 30 of the first hollow tubular segment to a downstream end 32 of the first hollow tubular segment 20.

The aerosol-cooling element 24 comprises a second hollow tubular segment 34. The second hollow tubular segment 34 is in the form of a hollow cylindrical tube made of cellulose acetate. The second hollow tubular segment 34 defines an internal cavity 36 that extends from an upstream end 38 of the second hollow tubular segment to a downstream end 40 of the second hollow tubular segment 34.

As shown by the dashed vertical line in FIG. 1, the aerosol-generating article 10 comprises a ventilation zone 60 provided at a location along the second hollow tubular segment 34.

The mouthpiece element 42 is in the form of a cylindrical plug of low-density cellulose acetate.

The aerosol-generating rod 12 comprises an aerosol-forming substrate. The aerosol-forming substrate may be a solid or a gel. The aerosol-forming substrate comprises one or more aerosol formers, such as glycerin or propylene glycol. The total aerosol former content of the aerosol-forming substrate may be greater than 30 percent by weight. The total aerosol former content of the aerosol-forming substrate may be greater than 40 percent by weight. The total aerosol former content of the aerosol-forming substrate may be greater than 45 percent by weight. The aerosol-forming substrate may be a non-tobacco substrate that does not comprise a tobacco-containing material. Alternatively, the aerosol-forming substrate may comprise tobacco-containing material. In addition, the aerosol-forming substrate may comprise water. The aerosol-forming substrate may have a water content of between 5 percent by weight and 35 percent by weight.

The aerosol-forming substrate may comprise nicotine. The aerosol-forming substrate may comprise one or more cellulose based agents. The aerosol-forming substrate may comprise one or more carboxylic acids. The one or more carboxylic acids may be selected from fumaric acid, maleic acid, and malic acid.

The aerosol-forming substrate may be a solid aerosol-generating film and the aerosol-generating rod 12 may comprise a gathered crimped paper sheet coated with the solid aerosol-generating film.

The aerosol-generating article 10 comprises a heating element, such as a susceptor 44, located within the aerosol-generating rod 12. As shown in FIG. 2, the susceptor 44 is surrounded by the aerosol-forming substrate and extends along the longitudinal axis of the aerosol-generating rod 12 from an upstream end of the aerosol-generating rod 12 to a downstream end of the aerosol-generating rod 12. The susceptor 44 is in direct contact with the aerosol-forming substrate.

The susceptor 44 may be in the form of a strip having a length of 12 millimeters, a width of 5 millimeters and a thickness of 60 micrometers. The susceptor 44 comprises at least two different materials. The susceptor 44 comprises at least two layers: a first layer of a first susceptor material disposed in physical contact with a second layer of a second susceptor material. The first susceptor material and the second susceptor material may each have a Curie temperature. In this case, the Curie temperature of the second susceptor material is lower than the Curie temperature of the first susceptor material. The first material may not have a Curie temperature. The first susceptor material may be aluminum, iron or stainless steel. The second susceptor material may be nickel or a nickel alloy.

Optionally, the aerosol-generating article 10 may comprise an upstream element located immediately upstream of the aerosol-generating rod 12 (not shown).

The upstream element may be in the form of a cylindrical plug of cellulose acetate circumscribed by a stiff wrapper.

FIG. 2 is a schematic cross-sectional view of an aerosol-generating system comprising an aerosol-generating device 200 and the aerosol-generating article 10 in which the aerosol-forming substrate of the aerosol-generating article is externally heated. The aerosol-generating article 10 is the aerosol-generating article described above with respect to FIG. 1.

The aerosol-generating device 200 comprises a heating chamber 210 for receiving the aerosol-generating article 10. The heating chamber 210 is formed by a stainless steel tube 230 and has at an upstream end a base 250.

The aerosol-generating article 10 is at least partially received in the heating chamber 210. As shown in FIG. 2, the aerosol-generating article 10 and stainless steel tube 230 are configured such that the proximal end 20 of the aerosol-generating article 10, on which a user of the aerosol-generating article 10 may puff during use, protrudes out of the heating chamber 210 and out of the aerosol-generating device 200 when the aerosol-generating article 10 is received in the heating chamber 210.

The aerosol-generating device 200 further comprises a heating system that comprises a heating element 245. The heating element 245 is bent around an upstream end of the stainless steel tube 230 to surround the upstream end. The portion of the stainless steel tube 230 surrounded by the heating element 245 corresponds to the portion of the heating chamber 210 in which the aerosol-forming substrate 225 of the aerosol-generating article 10 is received when the aerosol-generating article 10 is received in the heating chamber 210.

The heating system further comprises a temperature sensor 240. The temperature sensor 240 may be a Pt1000 type temperature sensor. The temperature sensor 240 is in thermal contact with heater tracks of the heating element 245 and is configured to measure the temperature of the heater tracks of the heating element 245.

The heating element 245 comprises a first adhesive layer, a first polyimide substrate layer, heating tracks, a second adhesive layer, a second polyimide layer and a heat shrink layer. The temperature sensor 240 is positioned between the second polyimide layer and the heat shrink layer. The temperature sensor 240 comprises connection wires for connecting the temperature sensor 240 to the controller 255.

The first adhesive layer is used to adhere the heating element 245 to the stainless steel tube 230. Sandwiching the heater tracks between the first and second polyimide layers provides a means of supporting the heater tracks in place and provides electrical insulation between the heater tracks and other components of the aerosol-generating device 200, particularly the stainless steel tube 230. Polyimide is advantageously flexible, electrically insulating and able to withstand the normal operation temperatures of the aerosol-generating device, in particular the heater tracks, in use. The heater tracks are continuous, electrically conductive tracks of stainless steel that are deposited on one of the first or second polyimide layers during manufacture. The heater tracks are configured to heat up when an electrical current is passed through them.

In other words, the heating element 245 is a resistively heated heating element 245. The heater tracks have a resistance of 1.1 ohms at room temperature. The second adhesive layer holds together the first and second polyimide layers, which maintains the heater tracks in place.

The heat shrink layer comprises a material that can withstand the normal operation temperatures of the aerosol-generating device, in particular the heater tracks, in use.

The aerosol-generating device 200 further comprises a power source 275, such as a battery. The power source 275 and the temperature sensor 240 are connected to a controller 255 via electrical wires and connections not shown completely in FIG. 2. The power supply 275 is configured to power the heating element 245 and is connected to connectors of the heater tracks. The heating of the heating element 245 by the power source 275 is controlled by the controller 255.

An airflow channel 265 extends from an air inlet 260 of the aerosol-generating device 200. Upstream of the heating chamber 210, the airflow channel 265 is primarily defined by an airflow channel wall 270. Downstream of the airflow channel wall 270, the airflow channel 265 passes through an air inlet defined in the base 250 of the heating chamber 210. The airflow channel 265 then extends through the heating chamber 210. When an aerosol-generating article 10 is received in the heating chamber 210, the airflow channel 265 passes through the aerosol-generating article 10 and extends through the mouthpiece 42.

During use of the aerosol-generating system, an aerosol-generating article 10 is inserted to the heating chamber 210 by a user of the system. The user then activates the device. This may be by, for example, pressing a button or inhaling through the mouthpiece 42 of the aerosol-generating article 10 which is detected by a puff sensor, not shown in FIG. 2.

Following activation, the controller 255 is configured to control the supply of power from the power source 275 to the heating element 245 to cause the heating tracks to heat up.

The heat from the heating tracks is conducted to the aerosol-forming substrate of the aerosol-generating article 10 through the stainless steel tube 230. This heating of the aerosol-forming substrate results in vapor being generated that is released into air drawing into the aerosol-forming article 10 via the airflow channel 265. The vapor then cools and condenses into an aerosol. Thus, when a user inhales through the mouthpiece 42, the generated aerosol is drawn through the aerosol-forming article 10 to be inhaled by a user.

The control of the heating by the controller 255 is based on temperature signals received from the temperature sensor 240. The controller 255 is configured to control the power provided to the heating element 245 to adjust the temperature of the heating element 245 based on the temperature measured by the temperature sensor.

Alternatively, the controller 255 may measure a value of electrical resistance of the heating element to obtain an indication of the temperature of the heating element 245. In such a scenario, the temperature sensor 240 is an optional component of the aerosol-generating device 200.

The controller 255 obtains an indication of the temperature of the heating element 245 (for example the electrical resistance of the heating element) by measuring the electrical resistance of the heating element 245. The indication of the temperature is used to adjust the current supplied to the heating element 245 in order to maintain the heating element 245 close to a target temperature. In other words, the controller adjusts the temperature of the heating element by adjusting the current supplied to the heating element 245.

This scheme relies on three or more temperature calibration points at which the resistance of the heating element 245 is measured. For temperatures intermediate the calibration points, the resistance values are interpolated from the values at the calibration points. The calibration point temperatures are chosen to cover the expected temperature range of the heating element 245 during operation. The calibration of the heating element 245 to obtain the calibration points may be performed at manufacture and the calibration points stored in a memory of the controller.

Controller 255 then adjusts the temperature of the heating element 245 by adjusting the current supplied to the heating element 245 based on the measured resistance value.

FIGS. 3 to 8 are graphs of heating element temperature against time showing exemplary heating profiles of the heating element. The illustrated heating profiles define temperature values for various heating modes (phases) and a corresponding duration of each heating mode (phase). Although four heating modes are shown, it is to be understood that the heating profiles may comprise more than four heating modes.

One or more heating profiles may be stored on a memory of the controller 255 or a memory associated with controller 255. The controller 255 may be configured to select a heating profile during user operation of the device to generate an aerosol. For example, the aerosol-generating device may comprise a means for identifying the aerosol-generating article or the aerosol-forming substrate and may select a heating profile based on the result of the identification. The heating profile may define the temperature and duration of all heating modes. Alternatively, the heating profile may define the temperature and duration of a subset of the heating modes, for example one or more of the heating modes subsequent to the pre-heating mode 310, 410, 510, 610, 710, 810.

In phase 310, 410, 510, 610, 710, 810 the heating element is at an initial temperature. Phase 310, 410, 510, 610, 710, 810 is a pre-heating phase in which the controller 255 is programmed to pre-heat the heating element 245 to a predetermined initial temperature for a predetermined duration of time.

The pre-heating phase ensures that, whatever the physical condition of the aerosol-forming substrate (dry or humid, for example), the time duration of the pre-heating phase is sufficient for the aerosol-forming substrate to reach a minimum operating temperature, in order to be ready to feed continuous power and reach the first operating temperature as quickly as possible for generating sufficient aerosol to be inhaled by the user.

In particular, aerosol-forming substrates comprising a non-tobacco material will have a higher thermal inertia than a tobacco-based aerosol-forming substrate because the non-tobacco aerosol-forming substrate comprises a higher aerosol-former content (for example, greater than 30 percent by weight) and a higher water content (for example greater than 5 percent by weight). Therefore, in the case of a non-tobacco aerosol-forming substrate having a higher moisture content, the pre-heating process ensures that a minimum operating temperature is reached before the main phase. The duration of the pre-heating mode is between 10 and 20 seconds, preferably 11 seconds.

Subsequent to the pre-heating phase, the controller is configured to enter a first heating mode 320, 420, 520, 620, 720, 820. The first heating mode 320, 420, 520, 620, 720, 820 may be entered in response to a timer indicating that the predetermined duration of the pre-heating phase 310, 410, 510, 610, 710, 810 has elapsed, user actuation of the aerosol-generating device, or after detection of a user puff. On entering the first heating mode 320, 420, 520, 620, 720, 820, the controller rapidly increases the temperature of the heating element from the initial temperature to a first temperature.

The first temperature is chosen so that desired volatile compounds are vaporized from the substrate but undesirable compounds, which are vaporized or generated at higher temperatures, are not released. Further, rapidly heating the heating element to the first temperature of the heating element improves the amount of vaporized desired volatile compounds, thereby providing improved delivery to the user from the first puff. The first temperature may be a maximum operating temperature of the heating element.

During the first heating mode 320, 420, 520, 620, 720, 820, the temperature remains constant at the first temperature for the duration of the first time period. The initial temperature is greater than ambient temperature and is between 140 and 170 degrees Celsius. The first temperature may be between 180 and 230 degrees Celsius. As discussed above, by heating the heating element to the first temperature of the heating element in the first heating mode 320, 420, 520, 620, 720, 820, the thermal inertia of the aerosol-forming substrate is overcome and the amount of vaporized desired volatile compounds in the aerosol inhaled by the user, such as nicotine and the aerosol former, is improved from the first puff.

After a first predetermined time period, the controller enters a second heating mode 330, 430, 530, 630, 730, 830. In the second heating mode 330, 430, 530, 630, 730, 830, the controller adjusts the temperature of the heating element to one or more second temperatures during a second predetermined time period. The one or more second temperatures may be between 180 and 230 degrees Celsius.

In the second heating mode 330, 430, 530, 630, 730, 830, the controller may adjust the temperature of the heating element to approximately correspond to the first temperature, as shown in FIG. 3.

In the second heating mode 330, 430, 530, 630, 730, 830, the controller may adjust the temperature of the heating element to be lower than the first temperature, as shown in FIGS. 4, 5, 6 and 7. At the end of the first heating mode 320, 420, 520, 620, 720, 820, heat will have spread throughout the aerosol-forming substrate. Lowering the temperature of the heating element in the second heating mode therefore enables the amount of vaporized desired volatile compounds in the aerosol inhaled by the user to remain consistent with the amount in the first heating mode 320, 420, 520, 620, 720, 820, thereby providing the same sensorial experience for the user.

In the second heating mode 330, 430, 530, 630, 730, 830, the controller may adjust the temperature of the heating element to be higher than the first temperature, as shown in FIG. 8.

In the second heating mode 330, 430, 530, 630, 730, 830, the controller may adjust the temperature of the heating element to a second temperature for the duration of the second time period, as shown in FIGS. 3, 4 and 8. Alternatively, in the second heating mode, the controller may adjust the temperature of the heating element in a plurality of consecutive temperature steps. For example, FIG. 5 show two temperature steps having the same time duration, where the temperature of the heating element is lower during the first temperature step than during the second temperature step. FIG. 6 shows two temperature steps, where the temperature of the heating element is lower during the first temperature step than during the second temperature step, and where the duration of the first temperature step is shorter than the duration of the second temperature step.

In the third heating mode 340, 440, 540, 640, 740, 840, the controller is configured to adjust the temperature of the heating element to a third temperature. The temperature of the heating element remains constant at the third temperature for the predetermined duration of the third time period. As shown in FIGS. 3 to 8, the third temperature approximately corresponds to the first temperature. At this stage of the usage session, the desired volatile compounds of the aerosol-forming substrate will have become depleted. Therefore, increasing the temperature of the heating element to approximately the first temperature enables the amount of vaporized desired volatile compounds in the aerosol inhaled by the user to remain consistent with the amount in the first and second heating modes.

Each of the predetermined time periods may be equal in length or different in length. For example, the first predetermined time period may be shorter than the subsequent second predetermined time period, for example as shown in FIGS. 4, 5 and 7. Additionally or alternatively, the first predetermined time period may be shorter than the third predetermined time period, for example as shown in FIGS. 4 and 5. The second predetermined time period may be longer than at least one of the first predetermined time period and the third predetermined time period, as shown for example in FIGS. 3 to 8. The first predetermined time period and the third predetermined time period may have the same time duration, for example as illustrated in FIG. 7.

The length of the first predetermined time period may be between 40 seconds and 150 seconds. The length of the second predetermined time period may be between 100 and 280 seconds. The length of the third predetermined time period may be between 30 seconds and 120 seconds.

The length of the first predetermined time period is chosen so that the aerosol-forming substrate can provide good delivery of volatilized desired compounds in the aerosol. The first predetermined time period being shorter than at least the second predetermined time period ensures good aerosol delivery to the user, while ensuring consistency in the user experience throughout the usage session.

The length of the second predetermined time period being longer than at least the first predetermined time period, in particular when the second temperature is lower than the first temperature, provides for improved control of the amount of vaporized desired volatile compounds in the aerosol inhaled by the user, thereby providing a consistent user experience for as long as possible throughout the usage session.

FIG. 9 is a flow diagram illustrating a method of controlling aerosol production in one of the aerosol-generating devices by heating a heating article inserted into the heating chamber of the aerosol-generating device as described above.

The method begins at step 910 when the user actuates heating of the heating element as described above. For example, the user may press one or more buttons of the aerosol-generating device to begin the heating of the heating element. Additionally or alternatively, the user may insert an aerosol-generating article into the heating chamber of the aerosol-generating device to being the heating of the heating element.

The method then proceeds to step 920, where the controller controls the power provided to the heating system to increase the temperature of the heating element from an ambient temperature to an initial temperature. During step 920, the controller is in the pre-heating mode and maintains the temperature of the heating element at the initial temperature for a predetermined time period.

At step 930, the controller enters a first heating mode. In the first heating mode, the controller adjusts the temperature of the heating element to increase the temperature from the initial temperature to a first temperature. The first temperature is maintained for a first predetermined time period.

At the end of the first predetermined time period, the controller enters a second heating mode at step 940. In the second heating mode, the controller adjusts the temperature of the heating element to a second temperature. The second temperature may be maintained for a second predetermined time period. Alternatively, the second temperature may be a first step of a plurality of temperature steps, each having a predefined duration, where the sum of the predefined duration of each temperature step is the duration of the second predetermined time period of the second heating mode. The second temperature may be lower than, approximately equal to, or greater than the first temperature.

At the end of the second predetermined time period, the controller enters a third heating mode at step 950. In the third heating mode, the controller adjusts the temperature of the heating element to a third temperature. The third temperature is maintained for a third predetermined time period. The third temperature is approximately equal to the first temperature and is maintained constant for the duration of the third time period.

It is to be understood that the Figures are for illustrative purposes and are not shown to scale. Moreover, it will be appreciated that the aerosol-generating articles and the aerosol-generating devices shown in the Figures and described in detail above may have additional elements to those discussed. Likewise, an aerosol-generating article or an aerosol-generating device according to the embodiments discussed here may have fewer elements. Moreover, it will now be apparent to one of ordinary skill in the art that various dimensions for the elements discussed in relation to the various embodiments discussed here are merely exemplary, and that suitable alternative dimensions for the various elements may be chosen.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein. Further, the expression a number A “approximately corresponds to” a number B in the context of this invention, is to be understood as the number A is equal to B±10% of B.

1.-15. (canceled)

16. A method of controlling aerosol production in an aerosol-generating device, the aerosol-generating device comprising: a heating chamber configured to at least partially receive an aerosol-generating article comprising an aerosol-forming substrate; a heating system comprising a heating element that is configured to externally heat the aerosol-forming substrate; and a power source configured to provide power to the heating system, the method comprising:
controlling the power during heating of the aerosol-forming substrate to form an aerosol for inhalation by a user to:
increase a temperature of the heating element from an initial temperature to a first temperature, wherein the first temperature is maintained constant for a first predetermined time period, wherein the first temperature is between 180 degrees Celsius and 230 degrees Celsius, and wherein the first predetermined time period has a duration of between 40 seconds and 150 seconds, and
adjust the temperature of the heating element to a second temperature for a second predetermined time period, wherein the second predetermined time period is directly subsequent to the first predetermined time period, wherein the second predetermined time period is longer than the first predetermined time period, and wherein a duration of the second predetermined time period is between 100 seconds and 280 seconds.

17. The method according to claim 16, wherein adjusting the temperature of the heating element to the second temperature during the second predetermined time period comprises lowering the temperature of the heating element from the first temperature.

18. The method according to claim 17, wherein lowering the temperature of the heating element from the first temperature comprises two consecutive temperature steps.

19. The method according to claim 18, wherein a temperature of a first temperature step is lower than a temperature of a second temperature step.

20. The method according to claim 16,
wherein controlling the power during heating of the aerosol-forming substrate to form an aerosol for inhalation by a user further comprises adjusting the temperature of the heating element to be constant and equal to a third temperature during a third predetermined time period, and
wherein the third temperature approximately corresponds to the first temperature and the third predetermined time period is subsequent to the second predetermined time period.

21. The method according to claim 16,
wherein the power is controlled during heating of the aerosol-forming substrate to form an aerosol for inhalation by a user based on a heating profile of a plurality of heating profiles, and
wherein each heating profile defines how to adjust the temperature of the heating element during each of the predetermined time periods.

22. The method according to claim 21, further comprising selecting the heating profile based on identifying the aerosol-generating article.

23. The method according to claim 16, wherein controlling the power further comprises, in a pre-heating mode, increasing the temperature of the heating element from an ambient temperature to the initial temperature.

24. The method according to claim 23, wherein the initial temperature is between 140 degrees Celsius and 170 degrees Celsius.

25. An aerosol-generating device, comprising:
a heating chamber configured to at least partially receive an aerosol-generating article comprising an aerosol-forming substrate;
a heating system comprising a heating element that is configured to externally heat the aerosol-forming substrate;
a power source configured to provide power to the heating system; and
a controller configured to control the power during heating of the aerosol-forming substrate to form an aerosol for inhalation by a user to:
increase a temperature of the heating element from an initial temperature to a first temperature, wherein the first temperature is maintained constant for a first predetermined time period, wherein the first temperature is between 180 degrees Celsius and 230 degrees Celsius, and wherein the first predetermined time period has a duration of between 40 seconds and 150 seconds, and
adjust the temperature of the heating element to a second temperature for a second predetermined time period, wherein the second predetermined time period is directly subsequent to the first predetermined time period, wherein the second predetermined time period is longer than the first predetermined time period, and wherein a duration of the second predetermined time period is between 100 seconds and 280 seconds.

26. The aerosol-generating device according to claim 25, wherein the heating element is a resistive heater.

27. A system, comprising:
the aerosol-generating device according to claim 25; and
an aerosol-generating article comprising the aerosol-forming substrate.

28. The system according to claim 27,
wherein the aerosol-forming substrate comprises one or more aerosol formers, and
wherein the aerosol-forming substrate comprises a total aerosol former content greater than or equal to 30 percent by weight.

29. The system according to claim 27, wherein the aerosol-forming substrate is a non-tobacco substrate.

30. The system according to claim 27, wherein the aerosol-forming substrate is a solid or a gel.
